(19) United States
(12) Patent Application Publication
(10) Pub. No.: US 2010/0327075 A1
(43) Pub. Date: Dec. 30, 2010

(54) AEROSOL GENERATION

(75) Inventor: Howard William Biddle, Cambridge (GB)

Correspondence Address: HARNESS, DICKEY & PIERCE, P.L.C., P.O. BOX 828, BLOOMFIELD HILLS, MI, 48303, US

(73) Assignee: 42 TECHNOLOGY LIMITED, Cambridge (GB)

(21) Appl. No.: 12/809,486

(22) PCT Filed: Dec. 18, 2008
(86) PCT No.: PCT/GB2008/051209

§ 371 Date: Aug. 9, 2010

Related U.S. Application Data
(60) Provisional application No. 61/033,581, filed on Mar. 4, 2008.

(30) Foreign Application Priority Data
Dec. 20, 2007 (GB) 0724789.3
Feb. 22, 2008 (GB) 0803280.7
Apr. 30, 2008 (GB) 0807843.8

(51) Int. Cl. B05B 17/04; B05B 1/26

(52) U.S. Cl. 239/11; 239/518

(57) ABSTRACT

An aerosol generation mechanism where a liquid mass is arranged to impinge a liquid-phobic surface (3). The liquid spreads across the liquid-phobic surface (3) without wetting it and at some point breaks up into an aerosol cloud (4).

This invention relates to the design of a device for generating liquid aerosols where the term ‘aerosol’ is taken to mean a fine mist of liquid droplets. In particular it relates to a mechanism which can be used as an alternative to known devices in which aerosol generation relies on forcing liquid or a mixture of liquid and gas through a small nozzle.

The formation of an aerosol is required for the delivery of liquids for a huge number of applications. For everyday purposes these include ‘personal care’ products such as hairsprays, deodorants, perfumes and after-shaves. For household purposes they include polishes, fragrances and cleaning fluids. For healthcare purposes they include delivery devices for drugs. Yet other applications include the delivery of insecticides, disinfectants, paints and lubricants. Canister based aerosol products are attractive because they are hermetically sealed and do not leak, go stale, or evaporate and can be pre-mixed for maximum formulation effectiveness.

There are innumerable other instances where the creation of an aerosol is desirable. Applications include humidification in air-conditioning systems, fire prevention, spray drying and the injection of fuel into burners and internal combustion engines.

Portable aerosol devices often comprise a canister which contains the liquid to be dispensed, a volatile, low boiling-point liquid propellant and a dip-tube and spray nozzle for the creation of the aerosol. Traditionally the propellant gas was a Carbonated Fluorocarbon (CFC) but these have been banned in many jurisdictions because they were so-called greenhouse gases. More recently CFCs have been replaced by Hydro-fluorocarbons (HFC) or hydrocarbons (HC) such as liquid butane. Neither of these solutions is ideal. Both HFCs and HCs still suffer from being greenhouse gases (albeit weakly); HFCs are more expensive than CFCs; and HCs are potentially flammable.

When the aerosol can is actuated, a mixture of dispensed product and propellant is ejected from the nozzle. On reaching atmospheric pressure the propellant boils. This helps both to create a fine mist and to propel the product at high velocity. A disadvantage of this approach is that more propellant is used than would be the case if a simple stream of pure liquid were propelled through the nozzle.

Because of the environmental impact, all Volatile Organic Compound (VOC) propellants are likely to be slowly phased out and perhaps banned in the foreseeable future and manufacturers of aerosols are seeking alternative low-cost solutions.

One development for avoiding volatile propellants has been the wider use of hand pump sprays. These devices can be acceptable where consistency of drop size and the fineness of the spray are not important for products such as furniture polish. However, because the available pressure from pump sprays is relatively low, and because of the way in which the aerosol is generated, they are not suitable for more demanding applications where relatively consistent and generally small aerosol droplet diameters are required. For many applications, such as healthcare where drug is to be inhaled, consistent aerosol droplet diameters of a single value. of less than about 5 microns are required. For household applications, droplets of between around 20 and 60 microns are required.

A further development is the use of a gas, typically air or nitrogen, as a propellant. This gas is compressed in the space above the liquid product to be dispensed and the gas pressure forces the liquid out of the canister. There are a number of disadvantages with this approach. The gas pressure cannot be too high for safety and cost reasons and this limits the performance of the device. Another problem is that as the product is dispensed, the gas pressure falls and further reduces the aerosol performance.

Numerous alternative solutions have been proposed to solve the problem of producing aerosols without using VOCs. WO 2004/089551 discloses a device which makes use of micro-fabricated high-precision nozzle structures to enable uniform nebulisation of a small dose of medicine. The contents are propelled through a number of convergent nozzles which form jets which collide with each other to form a spray. The pressure source is a simple, user activated spring and plunger mechanism.

DE102005030803 discloses an alternative approach that directs a jet of liquid onto a heated target. The hot surface vaporizes part of the liquid and causes the remainder of the liquid jet to form an aerosol. The problem with this solution is that it is costly to construct and is also costly in use because of the energy needed to heat the target.

There is a range of prior art describing aerosol generation devices whereby liquid streams, drops or streams of drops impact a surface to form an aerosol. Examples include fire sprinklers, humidifiers and agricultural sprayers. Prior art patents cover a range of applications and include GB557899, GB1429516, U.S. Pat. No. 5,362,446 and WO9219383. In the prior art the method of aerosol formation is not well understood and there are issues regarding wetting of the target surface so that the spray formation is not well controlled and coalescence can occur causing contamination and resulting in large uncontrolled drips. WO9219383 has tried to address this issue by shaping the surface that is impacted.

An object of one aspect of this invention is to create an aerosol which can use a low pressure source, is easy to manufacture and which creates a fine aerosol.

Accordingly, the present invention consists in one aspect in aerosol generation apparatus for generating a mist of liquid droplets, the apparatus comprising an liquid-phobic surface formed of a material which has a contact angle for said liquid of greater than 90°, when measured on a planar surface of the material, the liquid-phobic surface having micro-structure such that the contact angle for said liquid is greater than 120° and preferably greater than 150° when measured as an average over the planar surface of the material, and means for directing liquid at the surface to generate liquid droplets.

In a further aspect, the present invention consists in a method of generating aerosol in the form of a mist of liquid droplets, the method comprising the steps of providing a source of liquid; providing a surface which is constructed and orientated so as not to be wetted by the liquid; forming through contact of the liquid with said surface a film of liquid having a film edge region; and effecting ejection of liquid droplets from said edge region.

In one form of the invention, a liquid mass impacts a surface or target at high speed and the kinetic energy of the stream causes the liquid mass to break up into a mist of small droplets. The problem with using common materials for the target would be that the liquid stream ‘attaches’ to the surface due to surface wetting. This causes the small droplets created on impact to coalesce into much larger droplets and relatively little aerosol is created. In one form of the invention, the problem of surface wetting is avoided or significantly reduced by making the target from a super hydrophobic or super oleophobic material. Such materials resist wetting by aqueous liquids and oils and are hereafter referred to simply as liquid-phobic or super liquid-phobic as the case may be. The term liquid-phobic is not limited to aqueous and oil based liquids but can apply to materials and surfaces which are designed to resist wetting by any liquid. Liquid-phobic materials work by maximising the contact angle between the solid surface and the liquid; the higher the contact angle, the less likely it is that the material will be wetted. In other words it is beneficial to maximise the surface free energy of the material and the surface tension of the liquid. The non-wetting performance of these surfaces may typically be created by coating them with materials that are in themselves resistant to wetting such as Teflon® or PTFE. For super liquid-phobic surfaces, the non-wetting performance is then further enhanced by forming surface micro-structure that can be on different micro-scales for different effects. Examples include having micro pockets or hair-like structures on the surface of the base material. When liquid contacts these surface features it tends to sit on top of the features and the resulting high contact angle means that the liquid does not wet the bulk material.

Many plants exhibit hydrophobic and ‘super-hydrophobic’ properties, a classic example being the lotus leaf which has a surface covered with fine hairs. This property enables plants to avoid becoming waterlogged as any water droplets simply run off. This has the additional advantage of keeping the plant leaf clean as any dust is washed away with the drop. This phenomenon is a problem for manufacturers of agrochemicals as any liquid-based treatment tends to fall straight off the leaf. Consequently there is a body of scientific investigation which has been directed at understanding why liquids bounce off plant leaves. Similar investigations have been carried out to improve adhesion of drops to surfaces in applications such as spray painting and ink-jet printing.

In aspects of this invention, super liquid-phobic surfaces are used to create aerosols. In order to understand this invention it is helpful to understand what happens when a droplet hits a highly liquid-phobic surface. The behavior of a drop on hitting such a surface is dependant on a number of factors including the impact energy, the surface energy between the liquid and the surface, the liquid's properties (that may also be time dependant) and the interaction between the liquid and the gaseous medium. A simplified description of the behavior is that at low impact energy, the drop deforms and oscillates but will stay on the surface; at higher impact energies the drop deforms significantly, flattening into an elongated disc. The drop's surface tension then makes the drop recover its shape elastically and then rebound off the surface. At even higher energies the rebounding drop oscillates and collides with itself resulting in several satellite drops leaving the surface. As the impact energy rises, and with the correct fluid and surface properties, the drop firstly spreads to form a disc of liquid. Effects such as surface friction, surface tension, the viscosity of the liquid and the interaction between the liquid and the surrounding gas results in the edge of the liquid bulging to form a liquid annulus. As this liquid annulus expands instabilities develop creating ligaments which then break up into an aerosol of small droplets. The physics predicts that the droplets so created are essentially mono-dispersed.

In one embodiment of this invention, a drop or stream of liquid is arranged to impact a target with such high performance liquid-phobic surface properties. The extreme non-wetting properties of the surface does not allow the liquid to attach to the target and the liquid spreads as a thin film and then breaks up and leaves the surface as a fine-mist aerosol.

The angle of impact between the stream and the target is adjustable between 0° and 90° dependant upon the liquid and surface properties. The velocity and spread of the aerosol is partially dependant upon this angle. The advantages of this system are that it can work at a low pressure and is not dependent on liquefied gas propellants.

In some forms a super liquid-phobic surface may be considered as a surface formed of a material which has a contact angle for the liquid of greater than 90°, when measured on a planar surface of the material, the super liquid-phobic surface having micro-structure such that the contact angle for said liquid is greater than a value such as 120°; 130°, 140° or 150° when measured as an average over the planar surface of the material. In some applications, a still higher contact angle may be beneficial, such as 160° or 170°.

Alternatively, a super liquid-phobic surface may be considered as a surface over which droplets of the liquid in question can move without viscous loss in the liquid of the droplet.

An early explanation of liquid phobic surfaces was given by Wenzel who determined that when a liquid is in intimate contact with a microstructured surface, the conventional contact angle θ will change to θ_{W} given by:

cos θ_{W}=rcosθ

where r is the ratio of the actual area to the projected area. Wenzel's equation shows that microstructuring a surface amplifies the natural tendency of the surface. A hydrophobic surface (one that has an original contact angle greater than 90°) becomes more hydrophobic when microstructured—its new contact angle becomes greater than the original.

Cassie and Baxter found that if the liquid is suspended on the tops of microstructures, that is to say if the liquid fails to penetrate a nominal surface containing the outermost extremities of the surface material, θ will change to θ_{CB}, given by:

cos θ_{CB}=φ(cos θ+1)−1

where φ is the area fraction of the solid that touches the liquid. Liquid in the Cassie-Baxter state is more mobile than in the Wenzel state and it is generally preferred in certain forms of the present invention to operate in the Cassie-Baxter state. In addition to the surface parameters, it will be necessary to consider hydrostatic and hydrodynamic forces. To deliver to the surface liquid having sufficient kinetic energy to generate the required aerosol, it may be beneficial to reduce the component of liquid momentum orthogonal to the surface and to increase the component of liquid momentum tangential to the surface.

The present invention contemplates the generation of aerosols with droplets of oils, such as fragrances. By directly forming an aerosol with oil droplets, the preparatory steps of forming an aqueous dispersion or an alcohol or other solution may be avoided. In this case, of course, care will require to be taken to reduce surface energies in the oil delivery path “upstream” of the high surface energy aerosol generation mechanism. Super oleophobic surfaces are known and may be constructed using techniques analogous to the production of super hydrophobic surfaces. Additional attention may be paid to the microstructure and to re-entrant surface curvature. Preferred arrangements of microstructures may include arrays of capped pillars.

The invention will now be described solely by way of example and with reference to the accompanying drawings in which:

FIG. 1 shows a stream of liquid impacting a liquid-phobic surface to create an aerosol.

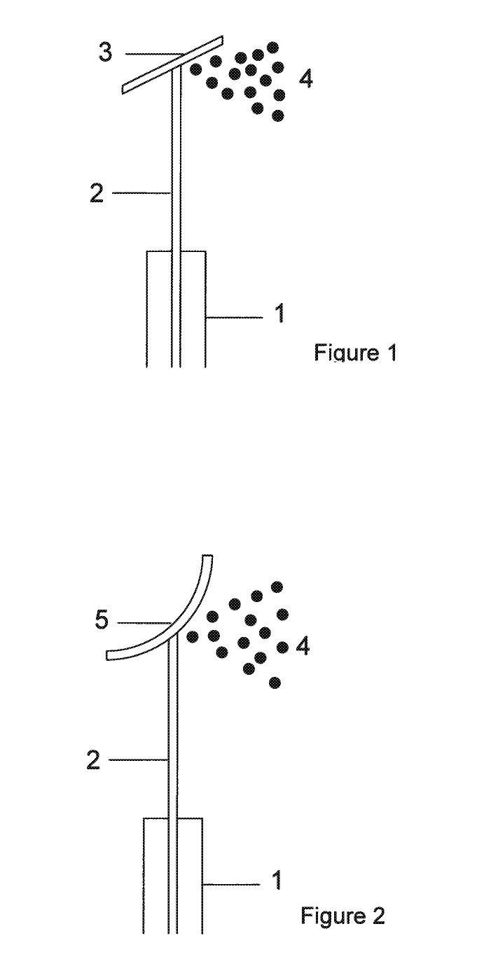

FIG. 2 shows the aerosol creation with an alternative configuration

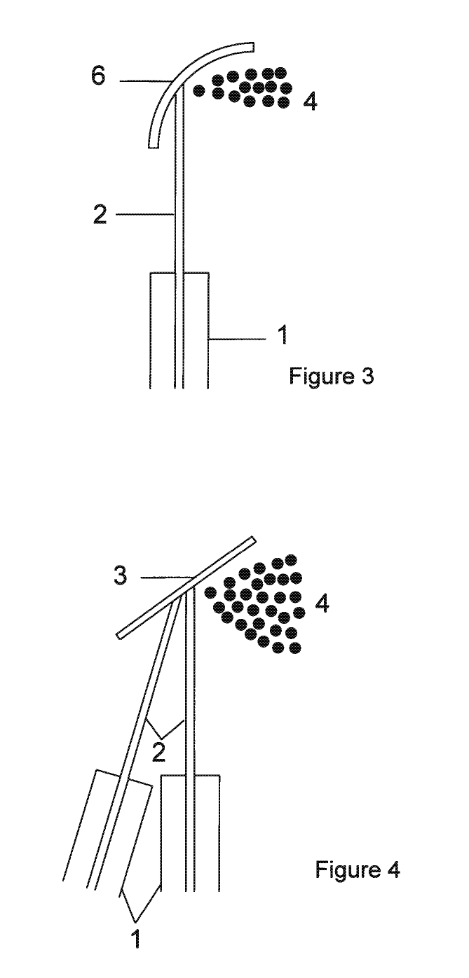

FIG. 3 shows the aerosol creation with a second alternative arrangement

FIG. 4 shows the aerosol creation with a third alternative arrangement

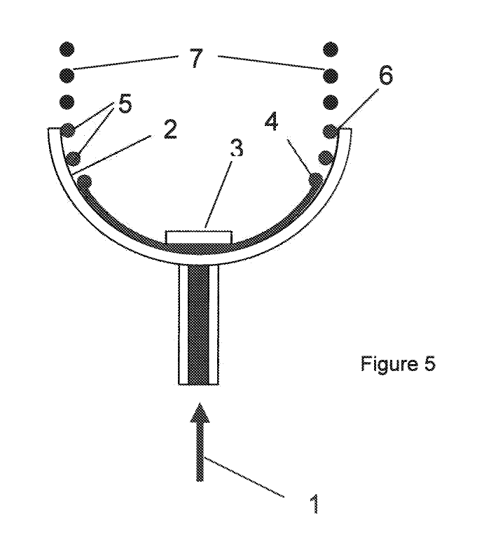

FIG. 5 shows the aerosol creation with a fourth alternative arrangement

In FIG. 1 a nozzle (1) issues a stream of liquid (2) to be formed into an aerosol. This liquid stream is arranged to impact a super liquid-phobic target (3) at a prescribed angle. The target can be of a material that has super liquid-phobic properties itself or one that is coated in a super liquid-phobic layer. Ideally the target is not much larger than the diameter of the liquid stream and that the corners are sharp and edges are also super liquid-phobic. Because of the energy of impact, the stream breaks up into an aerosol cloud (4).

Embodiments of this mechanism include, but are not restricted to, a parallel sided water jet between 0.05 and 0.35 mm diameter, pressurised to between 1 and 10 bar.

There are numerous materials and manufacturing techniques for the provision of super liquid-phobic surfaces. Typically, a micro structure is associated with a liquid phobic material by creating a microstructure in a base material and then coating that microstructure with a liquid phobic material (such as Teflon®) or by creating an appropriate microstructure in liquid phobic material. The microstructure can consist of regular or irregular projections from a base. In other arrangements, the microstructure can consist in pores or cavities. The microstructure can be regarded as defining a nominal surface containing the outermost extremities of the surface material, with voids in the micro structure defining openings in said nominal surface. In the case of microstructure consisting in pores or cavities, those voids may be discrete and not substantially interconnected. Such discrete pores or cavities at the nominal surface may usefully trap air pockets which further assist in resisting wetting of any part of the surface beneath the nominal surface.

Reference is directed to WO2007138286 which discloses a method of forming an ultra or super hydrophobic surface. A layer is formed from a mixture of low surface energy material and a sacrificial material; the layer is then treated to destroy the sacrificial material.

Other techniques and materials are disclosed in for example in CA 2260470, U.S. Pat. No. 6,660,363, CA 2356178, WO01/19932, WO 2004/037944; FR 2663568, JP 8/118190, and US 2002/034627. Surfaces produced in accordance with various of the examples provided in these published documents may be useful in working of the present invention and the content of each of these documents is to the extent permissible incorporated by reference herein.

FIG. 2 shows the stream of liquid impacting a convex liquid-phobic target (5) to create an aerosol with a differing dispersion pattern to that of a flat target.

FIG. 3 shows the stream impacting a concave liquid-phobic target (6) creating an aerosol with an alternative dispersion pattern. The use of such a concave surface may assist in inhibiting recombination of droplets.

FIG. 4 shows multiple streams of liquid impacting the liquid-phobic target to create a denser aerosol cloud.

In any of the figures the liquid stream can be a single liquid mass or a stream of liquid drops and the surface of the target may be textured to modify the characteristics of the aerosol and to enhance the break up of the spreading film.

It has been observed that an acute angle of impact between the liquid mass and the surface may with certain liquid velocities cause the surface to wet and lose its hydrophobic properties. In an alternative embodiment of this invention, the liquid is delivered to the surface with the major component of liquid momentum tangential to the surface rather than orthogonal to the surface. In one arrangement, essentially all the liquid momentum is tangential as the liquid first contacts the surface. In one such arrangement, liquid is introduced radially at the bottom of a concave surface such as a hemisphere.

As the liquid spreads out from the point of entry, the liquid is guided along the inside walls of the concave surface and at some point, distant from the point of entry a liquid annulus forms. As the liquid progresses further from the point of entry, the liquid annulus breaks into ligaments from which droplets are released. These droplets continue to be guided by the inside of the concave surface until they are released at the exit rim as an aerosol.

The advantage of this embodiment is that the force of the liquid acting normal to the liquid phobic surface is lower than in the case of an impacting jet. This makes it less likely that the surface will become wet for given surface parameters and at a given liquid velocity.

In a variation of this embodiment of the invention, a single jet or a plurality of jets, rather than a complete annulus of liquid are introduced tangentially onto a concave surface. As the jet or jets spread they firstly form sheets which then break into ligaments. As the ligaments spread out they become unstable and break into droplets so forming an aerosol.

In FIG. 5, a liquid stream 1 is introduced into the bottom of a concave surface 2. At the entrance to 2, a circular baffle 3 deflects the liquid to enter the surface 2, radially. This forms an annulus of liquid 4. At some point the annulus becomes unstable and breaks into a series of droplets 5. This stream continues to be guided by the concave surface 2 until it reaches the rim 6 and is released as an aerosol cloud 7.

It should be understood that the invention has been described by way of example only and a wide variety of modifications are possible without departing from the scope of the invention as set out in the appended claims. The skilled man will readily appreciate that a large number of approaches may be taken to the delivery of a liquid to a super liquid-phobic surface.

Whilst examples have been described with the detachment of droplets from the annular edge of a liquid film, other shapes of closed loop edges or linear edges may be appropriate in specific applications. Indeed, in other arrangements, droplets may be ejected centrally or otherwise from a body of liquid directed at a super liquid-phobic surface.

It will be noted that in the examples, droplets detach from the film under the action of the kinetic energy of the liquid directed at said surface; no reliance is placed upon a phase change (whether of a volatile liquid or upon striking a heated target). In certain cases however, aerosol parameters may be further controlled through vibration of all or parts of the liquid-phobic surface.

1.-35. (canceled)

36. Aerosol generation apparatus for generating a mist of liquid droplets, the apparatus comprising an liquid-phobic surface formed of a material which has a contact angle for said liquid of greater than 90°, when measured on a planar surface of the material, the liquid-phobic surface having micro-structure such that the contact angle for said liquid is greater than 120° and preferably greater than 150° when measured as an average over the planar surface of the material, a supply of said liquid and a liquid director for directing liquid at the surface to generate liquid droplets.

37. Aerosol generation apparatus according to claim 36, wherein the liquid director serves to form a film of the liquid having a film edge from which droplets detach.

38. Aerosol generation apparatus according to claim 37, in which droplets detach from said film edge under the action of the kinetic energy of the liquid directed at said surface.

39. Aerosol generation apparatus according to claim 37, wherein said film edge is annular.

40. Aerosol generation apparatus according to claim 39, wherein the annular edge is formed through flattening of a discrete drop of liquid impacting the surface.

41. Aerosol generation apparatus according to claim 39, wherein the annular edge is formed through shaping by the surface of a jet of liquid contacting the surface.

42. Aerosol generation apparatus according to claim 36, in which an aqueous liquid impacts a hydrophobic target or a non-aqueous liquid impacts an oleophobic target.

43. Aerosol generation apparatus according to claim 42 in which the liquid mass is a stream created in a nozzle that directs the liquid onto a target.

44. Aerosol generation apparatus according to claim 36, in which the liquid-phobic surface is non-planar.

45. Aerosol generation apparatus according to claim 36, in which liquid is introduced tangentially into a concave liquid-phobic surface at a point within the volume enclosed by the surface to create a radially extending flow along the surface.

46. Aerosol generation apparatus according to claim 36, in which the liquid-phobic surface has a micro structure with features in the range of 100 nm to 100 microns, preferably in the range of 1-50 microns, more preferably in the range of 1-25 microns.

47. Aerosol generation apparatus according to claim 36, in which the liquid-phobic surface has a micro structure defining a nominal surface containing the outermost extremities of the surface material, with cavities in the micro structure defining openings in said nominal surface.

48. Aerosol generation apparatus according to claim 47, wherein said cavities comprise discrete pores adapted to trap gas/air pockets.

49. Aerosol generation apparatus according to claim 47, in which said liquid director, the liquid-phobic surface and the liquid are constructed and adapted such that during aerosol generation the liquid remains on or above said nominal surface.

50. A method of generating an aerosol in the form of a mist of liquid droplets, the method comprising the steps of providing a source of liquid; providing a surface which is constructed and orientated so as not to be wetted by the liquid; forming through contact of the liquid with said surface a film of liquid having a film edge region; and effecting ejection of liquid droplets from said edge region.

51. A method according to claim 50, in which liquid droplets are ejected from said edge region under the action of the kinetic energy of the liquid as it is brought into contact with the surface.

52. A method according to claim 50, in which the surface and the liquid are essentially at the same temperature.

53. A method according to claim 50, wherein an annular edge region is formed through flattening of a discrete drop of liquid impacting the surface.

54. A method according to claim 50, wherein an annular edge region is formed through shaping by the surface of a jet of liquid contacting the surface.

55. A method according to claim 50, in which the surface has a micro structure defining a nominal surface containing the outermost extremities of the surface material, with cavities in the micro structure defining openings in said nominal surface.
